(19) United States
(12) Patent Application Publication
(10) Pub. No.: US 2019/0213998 A1
(43) Pub. Date: Jul. 11, 2019

(54) METHOD AND DEVICE FOR PROCESSING DATA VISUALIZATION INFORMATION

(71) Applicant: ZhongAn Information Technology Service Co., Ltd., Shenzhen (CN)

(72) Inventors: Haiyan XU, Shenzhen (CN); Ningyi ZHOU, Shenzhen (CN); Yinghua ZHU, Shenzhen (CN); Tianyu XU, Shenzhen (CN)

(21) Appl. No.: 16/354,678

(22) Filed: Mar. 15, 2019

Related U.S. Application Data
(63) Continuation of application No. PCT/CN2018/116415, filed on Nov. 20, 2018.

(30) Foreign Application Priority Data
Nov. 21, 2017 (CN) 201711166559.1

(51) Int. Cl. G10L 15/04; G10L 15/18; G06F 17/27; G10L 15/14; G10L 15/22

(52) U.S. Cl. CPC G10L 15/04; G10L 15/1815; G10L 2015/225; G10L 15/142; G10L 15/22; G06F 17/271

(57) ABSTRACT

The embodiments of the present invention provide a method for processing data visualization information, the method includes: analyzing whether a input information received is recognized; converting the input information that can be recognized into media information with a specified presentation form; determining, based on confirmation information of the media information, whether the input information is recognized correctly. When the input information is recognized correctly, determining based on a recognition result of the input information, a set of keywords. Determining, based on the set of keywords, an interactive instruction corresponding to the recognition result, and then executing the interactive instruction. By implementing the method of the embodiments of the present invention, the interaction between the user and the data display can be improved in the data visualization scenario, and the monotony of the current data visualization interaction mode can be broken up.

### CROSS-REFERENCE TO ASSOCIATED APPLICATIONS

This application is a continuation of International Application No. PCT/CN2018/116415 filed on Nov. 20, 2018, which claims priority to Chinese patent application No.201711166559.1 filed on Nov. 21, 2017. Both applications are incorporated herein by reference in their entireties.

### TECHNICAL FIELD

Embodiments of the present application relate to the field of computer data processing technology and in particular to a method and a device for processing data visualization information.

### BACKGROUND

Data visualization is a study about visual representation of data. Comparing with other manners for acquiring information, such as word-by-word and line-by-line reading, the data visualization is more helpful for people to understand the data from a visual perspective. In current data positioning and interaction manners, interaction is mainly achieved by clicking on a screen via a mouse or a touch screen, which relatively increases the learning cost, is not beneficial to remote visual displaying of data, and is not sufficiently convenient and fast.

Therefore, there is an urgent need for developing a method and a device that can be applied to achieve rapid interaction in the data visualization scenario.

### SUMMARY

In view of the above-mentioned problems, the embodiments of the present application propose an interactive manner of processing natural language and positioning and displaying information. The manner not only improves the efficiency of human-computer interaction during the data being displayed, but also effectively enhances the effect of visual display when the data is displayed visually in a specific scene such as a large screen.

According to an aspect of the embodiments of the present application, a method for processing data visualization information is provided. The method includes: performing a recognizability analysis on input information received; and determining whether the input information is recognized correctly, when the input information is recognized correctly, determining, based on a recognition result of the input information, an interactive instruction corresponding to the recognition result, and then executing the interactive instruction.

In an embodiment, the determining whether the input information is recognized correctly includes: converting the input information that can be recognized into media information with a specified presentation form, and determining, based on confirmation information of the media information, whether the input information is recognized correctly. The confirmation information is configured to indicate whether the media information presents the input information correctly.

In an embodiment, the determining, based on a recognition result of the input information, an interactive instruction corresponding to the recognition result includes: searching and matching the recognition result in a database, when a data field corresponding to the recognition result exists in the database, directly determining, based on the recognition result, an interactive instruction corresponding to the recognition result.

In an embodiment, the determining, based on the recognition result of the input information, an interactive instruction corresponding to the recognition result comprises: searching and matching the recognition result in the database, when a data field corresponding to the recognition result does not exist in the database, determining a set of keywords based on the recognition result, and determining the interactive instruction corresponding to the recognition result based on the set of keywords.

In an embodiment, the method further includes: when the input information is received, judging whether the input information is received successfully; when the input information is received unsuccessfully, first feedback information used for indicating that the input information is received unsuccessfully is generated.

In an embodiment, the performing a recognizability analysis on the input information received includes: analyzing the input information based on a recognition model for recognizing the input information, and then determining recognizability of the input information received. When the input information isn't recognized, second feedback information used for indicating that the input information isn't recognized is generated.

In an embodiment, when the input information is recognized incorrectly, third feedback information used for indicating that the input information is recognized incorrectly is generated.

In an embodiment, the determining a set of keywords based on the recognition result includes: recognizing the input information as a semantic text, and extracting the set of keywords from the semantic text. The set of keywords includes at least one field.

In an embodiment, the determining, based on the set of keywords, an interactive instruction corresponding to the recognition result includes: matching the set of keywords with data fields in the database; when fields in the set of keywords match the data fields in the database, determining the interactive instruction based on a matching result; and when fields in the set of keywords do not match the data fields in the database, fourth feedback information is generated. The fourth feedback information is used for indicating that fields in the set of keywords do not match the data field in the database.

In an embodiment, the input information includes at least one of a voice, a touch and a body motion.

In an embodiment, the method also includes: when the input information is received, judging whether the input information is received successfully. The input information includes the voice. The judging whether the input information is received successfully includes judging whether the voice is received successfully based on a first threshold.

In a further embodiment, the first threshold includes any one or any combination of: a voice length threshold, a voice strength threshold, and a voice domain threshold.

In an embodiment, the media information includes at least one of the following: a video, an audio, a picture, or a text.

According to another aspect of the embodiments of the present application, a computer readable storage medium is provided. A computer readable program instruction is stored on the computer readable storage medium. When the computer readable program instruction is executed, a method described above is executed.

According to another aspect of the embodiments of the present application, a device for processing data visualization information is provided. The device includes: a processor, and a memory, configured to store an instruction. When the instruction is executed, the processor implements the following steps: performing a recognizability analysis on input information received; and determining whether the input information is recognized correctly, when the input information is recognized correctly, determining, based on a recognition result of the input information, an interactive instruction corresponding to the recognition result, and then executing the interactive instruction.

In an embodiment, when implementing the step of determining whether the input information is recognized correctly, the processor specifically implements the following steps: converting the input information that can be recognized into media information with a specified presentation form, and determining, based on confirmation information of the media information, whether the input information is recognized correctly, wherein the confirmation information is configured to indicate whether the media information presents the input information correctly.

In an embodiment, when implementing the step of determining, based on a recognition result of the input information, an interactive instruction corresponding to the recognition result, the processor specifically implements the following steps: searching and matching the recognition result in a database, when a data field corresponding to the recognition result exists in the database, directly determining, based on the recognition result, the interactive instruction corresponding to the recognition result.

In an embodiment, when implementing the step of determining, based on the recognition result of the input information, an interactive instruction corresponding to the recognition result, the processor specifically implements the following steps: searching and matching the recognition result in the database; when a data field corresponding to the recognition result does not exist in the database, determining a set of keywords based on the recognition result; and determining the interactive instruction corresponding to the recognition result based on the set of keywords.

In an embodiment, the processor further implements the following steps: when the input information is received, judging whether the input information is received successfully; wherein when the input information is received unsuccessfully, first feedback information used for indicating that the input information is received unsuccessfully is generated.

In an embodiment, when implementing the step of performing a recognizability analysis on the received input information, the processor specifically implements the following steps: analyzing the input information based on a recognition model for recognizing the input information, and then determining the recognizability of the input information received; wherein when the input information isn't recognized, second feedback information used for indicating that the input information isn't recognized is generated.

In an embodiment, the processor further implements the following steps: when the input information is recognized incorrectly, third feedback information used for indicating that the input information is recognized incorrectly is generated.

In an embodiment, when implementing the step of determining a set of keywords based on the recognition result, the processor specifically implements the following steps: recognizing the input information as a semantic text, and extracting the set of keywords from the semantic text, wherein the set of keywords comprises at least one field.

In an embodiment, when implementing the step of determining, based on the set of keywords, an interactive instruction corresponding to the recognition result, the processor specifically implements the following steps: matching the set of keywords with data fields in the database, and when fields in the set of keywords match the data fields in the database, determining the interactive instruction based on a matching result.

In an embodiment, when implementing the step of determining, based on the set of keywords, an interactive instruction corresponding to the recognition result, the processor specifically implements the following steps: generating fourth feedback information when fields in the set of keywords do not match the data fields in the database, wherein the fourth feedback information is used for indicating that fields in the set of keywords do not match the data fields in the database.

In an embodiment, the input information comprises at least one of a voice, a touch and a body motion.

In an embodiment, the processor further implements the following steps: when the input information is received, judging whether the input information is received successfully, wherein the input information comprises the voice; wherein the judging whether the input information is received successfully comprises: judging whether the voice is received successfully based on a first threshold.

In an embodiment, the first threshold comprises any one or any combination of: a voice length threshold, a voice strength threshold and a voice domain threshold.

In an embodiment, the media information comprises at least one of the following: a video, an audio, a picture or a text.

By implementing the technical scheme of embodiments of the present application, the interaction between the user and the data display can be improved in the data visualization scenario, and the monotony of the current data visualization interaction mode can be broken up.

### BRIEF DESCRIPTION OF DRAWINGS

Embodiments are shown and illustrated with reference to the accompanying drawings. These drawings are used to illustrate the basic principles and thus only show the aspects necessary to understand the basic principles. These drawings are not proportional. In the drawings, the same reference numerals indicate similar features.

FIG. 1 shows a method for processing data visualization information according to an embodiment of the present application.

FIG. 2 shows a method for processing data visualization information based on voice recognition according to an embodiment of the present application.

FIG. 3 is a schematic diagram of a device for processing data visualization information according to an embodiment of the present invention.

### DETAILED DESCRIPTION

In the detailed description of the following preferred embodiments, the reference is made to the accompanying drawings that form a part of the prevent application. The accompanying drawings illustrate, by way of example, specific embodiments that may achieve the present application. The exemplary embodiments are not intended to be exhaustive of all embodiments in accordance with the present application. It should be understood that, without departing from the scope of the present application, other embodiments may be utilized or the embodiments may be made structural or logical modifications. Therefore the following specific description is not restrictive, and the scope of the present application is limited by the appended claims.

Techniques, methods and apparatus known to those ordinary skilled in the relevant art may not be discussed in detail, but the techniques, methods and apparatus should be considered as a part of the specification under appropriate circumstances. A connecting line between the units in the drawings is used to illustration purposes only. The connecting line between the units in the drawings indicates that at least the units of both ends of the connecting line communicate with each other, and is not intended to limit that there is no communication between the units that are not connected.

With reference to the accompanying drawings, an interactive manner for processing natural language and positioning and displaying information, based on a data visualization scenario and provided by embodiments of the present application, is further described in detail as follows.

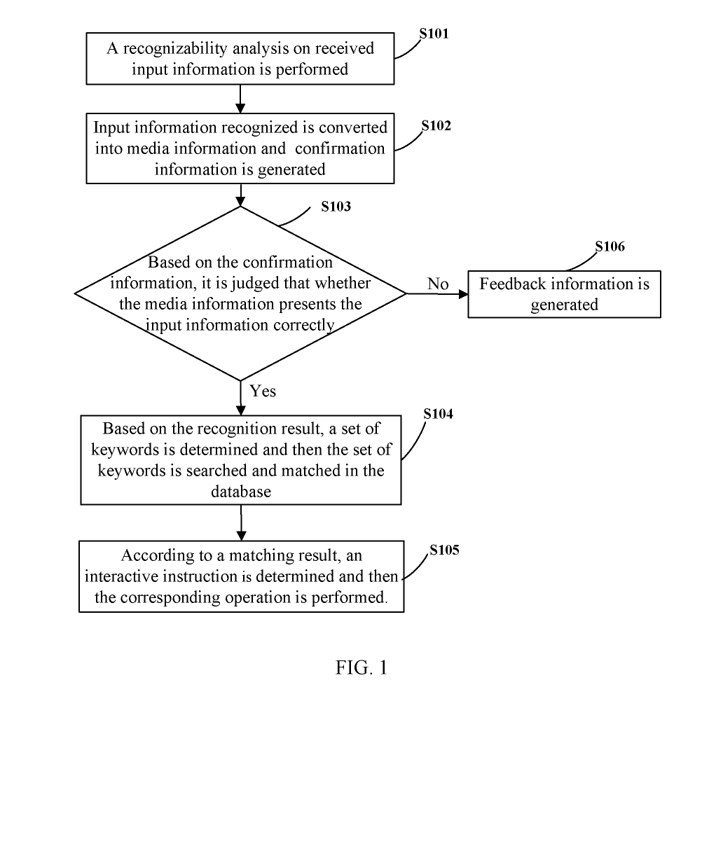

FIG. 1 shows a method for processing data visualization information according to an embodiment of the present application. The method includes:

Step S101: a recognizability analysis on received input information is performed.

In Step S101, the recognizability analysis on received input information is performed, and then a recognition model is used to recognize the recognized input information. It should be understood that input information of a user may be, but not limited to, indicative information such as a voice, a touch or a body motion. For example, when the user inputs a voice, the voice is recognized by a voice recognition model. Similarly, when the user inputs a gesture, the gesture is recognized by a gesture recognition model. By Step S101, the recognition model can obtain a recognition result of the input information.

Step S102: input information recognized is converted into media information and confirmation information is generated.

In Step S102, the input information or the recognition result of the input information obtained in Step S101 is converted into media information with a specified presentation form. By Step S102, the user can determine whether the input information is recognized correctly, and then corresponding confirmation information is generated. It should be understood that the media information may include user-visible images, a text, a user-audible voice or the like, and the media information may have a form different from the input information. Therefore, the user can receive the recognition result in a variety of way.

Step S103: based on the confirmation information, it is judged that whether the media information presents the input information correctly.

In Step S103, the user can judge whether the input information is recognized correctly based on the media information. If the input information is recognized incorrectly, feedback information is generated (Step S106). The feedback information is used to prompt the user to re-input because the current input information is recognized incorrectly.

If the input information is recognized correctly, Step S104 is performed, i.e., based on the recognition result, a set of keywords is determined and then the set of keywords is searched and matched in the database.

As can be seen from the above-mentioned, the input information is not limited to indicative information such as a voice, a touch or a body motion. After the recognition system recognizes the input information, the set of keywords corresponding to the input information can be determined based on the recognition result. In this embodiment, the recognition result is a semantic text corresponding to the input information, and the set of keywords may include at least one field which is extracted from the semantic text and can reflect the intent of the input information.

After the set of keywords is determined, based on fields included in the set of keywords, it is performed that the database is searched and whether data fields corresponding to the fields exist in the database is judged. When data fields corresponding to the fields exist in the database data field, matching between the set of keywords and the data field in the database can be achieved, and then an interactive instruction corresponding to the set of keywords is determined. Obviously, by extracting the set of keywords, the intention of the input information can be determined.

Step S105: According to a matching result, an interactive instruction is determined and then the corresponding operation is performed.

As can be seen from Step S104, when the set of keywords matches with the data fields in the database, the interactive instruction corresponding to the set of keywords is determined. When the interactive instruction is determined, the system executes the interactive instruction and an operation corresponding to the input information of the user is generated.

By executing the method for processing information in FIG. 1, response to various forms of the input information of the user in the data visualization scenario can be realized, so the operation can be simplified and the input information of the user can be displayed better.

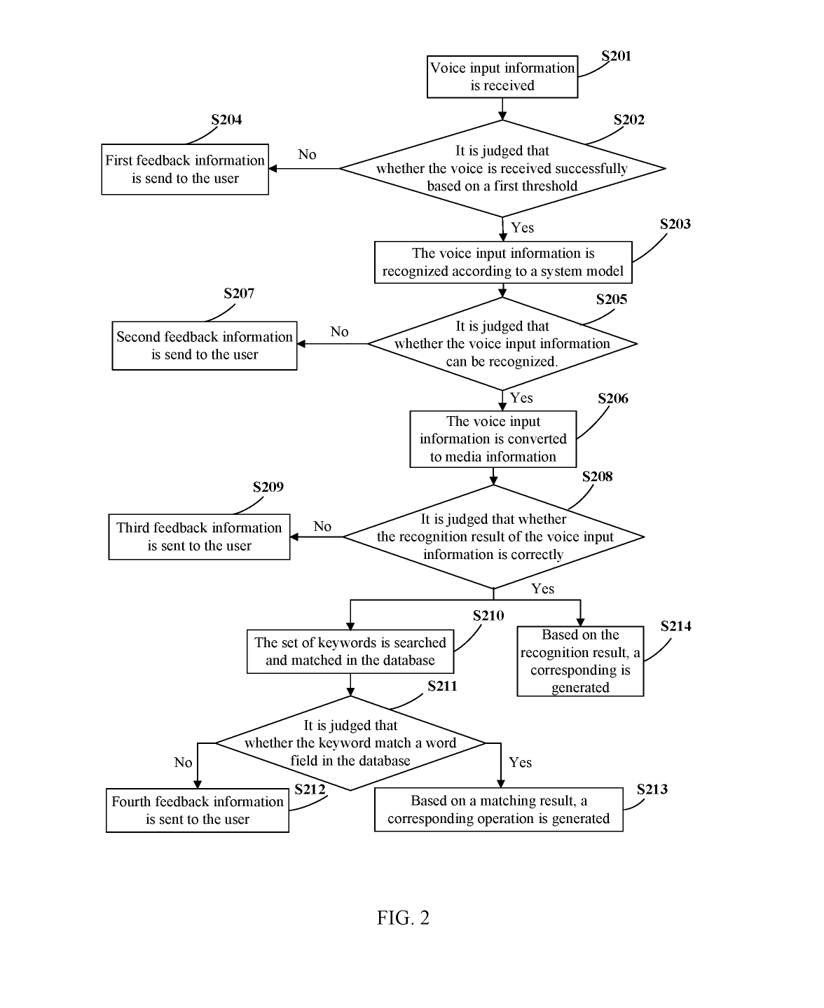

In order to further describe the embodiment, referring to the FIG. 2, the following is illustrated with taking input information being voice information as an example. Those skilled in the art can understand that although the method in FIG. 2 takes the voice information as an example, the method in FIG. 2 is also applicable to the input information in other forms, including but not limited to a body motion, a touch and the like.

FIG. 2 is a method for processing data visualization information based on voice recognition according to an embodiment of the present application.

The method includes:

Step S201: voice input information is received.

In Step S201, an instruction emit by the user will be received by a terminal device. The terminal device may be a mobile phone, a microphone or the like that has been matched with display content. When the terminal device is a voice receiving device having the capability of further processing (for example, recognition) of the voice input information, the terminal device can process the voice input information according to the setting. If the terminal device is the voice receiving device such as a microphone, the terminal device will transmit the received voice input information to a designated processing device.

Step S202: it is judged that whether the voice is received successfully based on a first threshold.

In Step S202, based on a first threshold, it is judged that whether the terminal device receives the voice input information successfully. Due to environmental influence or a working condition of the terminal device itself, the terminal device may not be able to receive or completely receive the voice input information. For example, a voice length threshold may be set at the terminal device. When a length of the received voice input information is less than the voice length threshold, it may be judged that the voice input information is invalid information. Similarly, a voice strength threshold may also be set. When strength of the received voice input information is less than the voice strength threshold, it may be judged that the voice input information is invalid information.

It should be understood that, according to application requirements, a corresponding threshold may be set to judge whether the voice is received successfully, for example, a voice domain threshold. This embodiment does not need to enumerate all possible implementations. After performing Step S202, the receiving of the voice input information can be judged. As can be seen from the above, the first threshold may include, but is not limited to, the voice length threshold, the voice strength threshold, or the voice domain threshold, and may also include a combination of the above-mentioned types of thresholds and the like.

When a judging result of Step S202 is no, i.e., the voice input information is not received successfully, Step S204 is performed and first feedback information is send to the user. It should be understood that the first feedback information may be any form of information that can be perceived by the user.

When a judging result of Step S202 is yes, i.e., the voice input information is received successfully, Step S203 is performed and the voice input information is recognized according to a system model. The system model in the embodiment can adopt any existing speech recognition model, such as a Hidden Markov Model. Similarly, the system model can also be achieved through training by artificial neural network.

Step S205: it is judged that whether the voice input information can be recognized.

In Step S205, it is judged that whether the voice input information can be recognized. For some irregular voice, unclear voice or other voice that exceeds the recognition ability of the voice recognition model, even if the voice is received successfully, the voice cannot be recognized. Therefore, it can be judged that whether the voice input information can be recognized by performing Step S205.

When the judging result of step S205 is no, i.e., the voice input information cannot be recognized, Step S207 is performed and second feedback information is send to the user. It should be understood that the second feedback information may be any form of information that can be perceived by the user.

When the judging result of step S205 is yes, i.e., the voice input information can be recognized successfully, Step S206 is performed and the voice input information is converted to media information. It should be understood that the media information may include an image visible to the user, text, or voice that the user can hear and the like. Therefore, the user can receive a recognition result in various ways.

Step S208: it is judged that whether the recognition result of the voice input information is correct?

In Step S208, the recognition result of the voice input information is judged. In the present embodiment, since the voice input information is converted into the media information, according to confirmation information of the user, it is judged that whether the recognition result is correct. The recognition result may be semantic text corresponding to the input information.

It should be understood that, in other embodiments, the system does not require further confirmation from the user, and may judge whether the recognition information is correct or not, and thus, Step S206 may optionally not be performed.

When the judging result of Step S208 is no, i.e., the recognition result corresponding to the voice input information is wrong, Step S207 is performed and third feedback information is sent to the user. It should be understood that the third feedback information may be any form of information that can be perceived by the user.

When the judging result of Step S208 is yes, i.e., the recognition result corresponding to the voice input information is right, Step S210 or Step S214 is performed. In order to better illustrate the present embodiment, the following description will be made by taking the recognition result as “I really want to go to Beijing” as an example.

Step S210 to Step S213 are first illustrated.

When the recognition result corresponding to the voice input information is correct, the recognition result can be analyzed (for example, split) and then a set of keywords associated with the recognition result is determined, for example, according to a specific field or a semantic algorithm, the set of keywords is extracted from the recognition result. By extracting the recognition result “I really want to go to Beijing”, the keywords “I”, “Want to go”, and “Beijing” are extracted. After the above-mentioned keywords are determined, it is performed that searching and matching the recognition result in the database (for example, corpus).

Step S211: it is judged that whether the keyword match a word field in the database.

In Step S211, a match situation between the keywords and data field in the database is judged.

When the judging result of Step S211 is no, i.e., there is no data field in the database that matches the current keywords, Step S212 is performed and fourth feedback information is sent to the user. It should be understood that the fourth feedback information may be any form of information that can be perceived by the user.

When the judging result of step S211 is yes, i.e., there is the data field in the database that matches the current keywords, Step S213 is performed, and based on a matching result, a corresponding operation is generated. In other words, a corresponding action is triggered based on the keywords “I”, “Want to go” and “Beijing”. In a data visualization scenario, the current user may be provided with the availability of alternative vehicles such as a route to Beijing, a flight to Beijing, a train to Beijing and the like.

When a fixed receivable field is directly configured in the system, the user can directly speak a pre-configured field receivable by the device during performing on-site demonstrations and explanations of the data visualization. During the demonstrations, when a terminal device receives an instruction, the instruction is compared with the background data directly, and a required data is displayed on the display device quickly. In other words, if a data field corresponding to the voice “I really want to go to Beijing” has been stored at a terminal device or a processing device, it is not necessary to extract keywords from the voice, and the operation (Step S214) corresponding to the data field can be directly performed.

Through the above-mentioned method, in data visualization scenarios, recognizing voice and processing natural language are implemented, which improves the interaction between the user and the data display, and breaks up the monotony of the current data visualization interaction mode. The user can complete the operation through transmitting natural language, which reduces the complexity of data visualization interoperation, and improves the display efficiency. The method mentioned above is especially suitable for a large-screen display scene.

Although the above-mentioned embodiments adopt the voice input information as embodiments, those skilled in the art can understand that indicative information such as a body motion, a touch and the like is also applicable to the above method. For example, when a video component in the terminal device captures an action that the user clasps his or her hands, the action is recognized by a corresponding action recognition model. For example, through being trained, the action that the user clasps his or her hands may be associated with a “shutdown” function, and when the action recognition model recognizes the action correctly, the “shutdown” function is triggered.

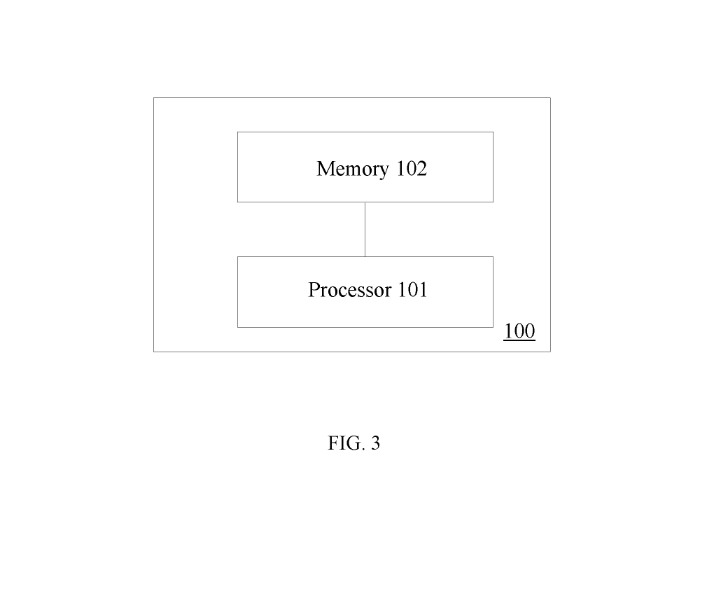

FIG. 3 shows a schematic diagram of a device 100 for processing data visualization information according to an embodiment of the present invention. As shown in FIG. 3, the device 100 includes a memory 102, a processor 101, and an instruction stored in the memory 102 and executed by the processor 101; when the instruction is executed by the processor 101, the processor 101 implements anyone of the methods for processing data visualization information according to embodiments described above.

A flow of the method for processing information in FIG. 1 and FIG. 2 also represent machine readable instructions including a program executed by a processor. The program can be embodied in software stored in a tangible computer readable medium such as a CD-ROM, a floppy disk, a hard disk, a digital versatile disk (DVD), a Blu-ray disk or other form of memory. Alternatively, some or all of the steps in the methods in FIG. 1 and FIG. 2 may be implemented by using any combination of an application specific integrated circuit (ASIC), programmable logic device (PLD), field programmable logic device (EPLD), discrete logic, hardware, firmware and the like. In addition, although the flowchart shown in FIGS. 1 and 2 describes the method for processing data, the steps in the method for processing data may be modified, deleted, or merged.

As described above, an example process of FIG. 1 and an example process of FIG. 2 can be implemented by using coded instructions (such as computer readable instructions). The coded instructions are stored in the tangible computer readable media, such as a hard disk, a flash memory, a read only memory (ROM), a compact disk (CD), a digital versatile disk (DVD), a cache, a random access memory (RAM), and/or any other storage media in which the information can be stored for any time (for example, long-term storage, permanent storage, transient storage; temporary buffering; and/or caching of information). As used herein, the term tangible computer readable medium is expressly defined to include any type of computer readable storage of information. Additionally or alternatively, the example process of FIG. 1 and the example process of FIG. 2 may be implemented by using coded instructions (such as computer readable instructions). The coded instructions are stored in non-transitory computer readable media, such as a hard disk, a flash memory, a read only memory (ROM), a compact disk (CD), a digital versatile disk (DVD), a cache, a random access memory (RAM), and/or any other storage media in which the information can be stored for any time (for example, long-term storage, permanent storage, transient storage, temporary buffering, and/or caching of information). It should be understood that the computer readable instructions may also be stored in a web server or in a cloud platform for the convenience of users.

In addition, although the operations are depicted in a particular order, this should not be understood that operations are performed in the particular order shown or in a sequential order, or all the shown operations are performed to obtain the desired results. In some cases, multitasking or parallel processing can be beneficial. Similarly, although the above-mentioned discussion contains specific implementation details, it should not be construed as limiting the scope of the invention or the scope of the claims, and it should be construed as describing a specific embodiment of a specific invention.

In the detailed description, certain features that are described in the context of separate embodiments can also be implemented in a single embodiment. Conversely, the various features described in the context of a single embodiment may also be implemented separately in multiple embodiments or in any suitable sub-combination.

Therefore, although the present application is described with reference to specific embodiments, which are merely intended to be illustrative and not limiting the present application, it is apparent to those skilled in the art that the disclosed embodiments can be changed, added or deleted without departing from the spirit and scope of protection of the application.

What is claimed is:

1. A method for processing data visualization information, comprising:
performing a recognizability analysis on received input information; and
determining whether the input information is recognized correctly, when the input information is recognized correctly, determining, based on a recognition result of the input information, an interactive instruction corresponding to the recognition result, and then executing the interactive instruction.

2. The method of claim 1, wherein the determining whether the input information is recognized correctly comprises:
converting the input information that can be recognized into media information with a specified presentation form, and determining, based on confirmation information of the media information, whether the input information is recognized correctly, wherein the confirmation information is configured to indicate whether the media information presents the input information correctly.

3. The method of claim 1, wherein the determining, based on a recognition result of the input information, an interactive instruction corresponding to the recognition result comprises: searching and matching the recognition result in a database, when a data field corresponding to the recognition result exists in the database, directly determining, based on the recognition result, the interactive instruction corresponding to the recognition result.

4. The method of claim 1, wherein the determining, based on the recognition result of the input information, an interactive instruction corresponding to the recognition result comprises: searching and matching the recognition result in the database; when a data field corresponding to the recognition result does not exist in the database, determining a set of keywords based on the recognition result; and determining the interactive instruction corresponding to the recognition result based on the set of keywords.

5. The method of claim 1, further comprising: when the input information is received, judging whether the input information is received successfully; wherein when the input information is received unsuccessfully, first feedback information used for indicating that the input information is received unsuccessfully is generated.

6. The method of claim 1, wherein the performing a recognizability analysis on the received input information comprises:
analyzing the input information based on a recognition model for recognizing the input information, and then determining the recognizability of the input information received; wherein when the input information isn't recognized, second feedback information used for indicating that the input information isn't recognized is generated.

7. The method of claim 2, wherein when the input information is recognized incorrectly, third feedback information used for indicating that the input information is recognized incorrectly is generated.

8. The method of claim 4, wherein the determining a set of keywords based on the recognition result comprises:
recognizing the input information as a semantic text, and extracting the set of keywords from the semantic text, wherein the set of keywords comprises at least one field.

9. The method of claim 4, wherein the determining, based on the set of keywords, an interactive instruction corresponding to the recognition result comprises:
matching the set of keywords with data fields in the database; and when fields in the set of keywords match the data fields in the database, determining the interactive instruction based on a matching result.

10. The method of claim 9, wherein the determining, based on the set of keywords, an interactive instruction corresponding to the recognition result further comprises:
generating fourth feedback information when fields in the set of keywords do not match the data fields in the database, wherein the fourth feedback information is used for indicating that fields in the set of keywords do not match the data fields in the database.

11. The method of claim 1, further comprising: when the input information is received, judging whether the input information is received successfully, wherein the input information comprises the voice; wherein the judging whether the input information is received successfully comprises: judging whether the voice is received successfully based on a first threshold.

12. A device for processing data visualization information, comprising:
a processor; and
a memory, configured to store an instruction, wherein when the instruction is executed, the processor implements the following steps:
performing a recognizability analysis on received input information; and
determining whether the input information is recognized correctly, when the input information is recognized correctly, determining, based on a recognition result of the input information, an interactive instruction corresponding to the recognition result, and then executing the interactive instruction.

13. The device for processing data visualization information of claim 12, wherein when implementing the step of determining whether the input information is recognized correctly, the processor specifically implements the following steps:
converting the input information that can be recognized into media information with a specified presentation form, and determining, based on confirmation information of the media information, whether the input information is recognized correctly, wherein the confirmation information is configured to indicate whether the media information presents the input information correctly.

14. The device for processing data visualization information of claim 12, wherein when implementing the step of determining, based on a recognition result of the input information, an interactive instruction corresponding to the recognition result, the processor specifically implements the following steps:
searching and matching the recognition result in a database, when a data field corresponding to the recognition result exists in the database, directly determining, based on the recognition result, the interactive instruction corresponding to the recognition result.

15. The device for processing data visualization information of claim 12, wherein when implementing the step of determining, based on the recognition result of the input information, an interactive instruction corresponding to the recognition result, the processor specifically implements the following steps:
searching and matching the recognition result in the database; when a data field corresponding to the recognition result does not exist in the database, determining a set of keywords based on the recognition result; and determining the interactive instruction corresponding to the recognition result based on the set of keywords.

16. The device for processing data visualization information of claim 12, wherein the processor further implements the following steps:
when the input information is received, judging whether the input information is received successfully; wherein when the input information is received unsuccessfully, first feedback information used for indicating that the input information is received unsuccessfully is generated.

17. The device for processing data visualization information of claim 12, wherein when implementing the step of performing a recognizability analysis on the received input information, the processor specifically implements the following steps:
analyzing the input information based on a recognition model for recognizing the input information, and then determining the recognizability of the input information received; wherein when the input information isn't recognized, second feedback information used for indicating that the input information isn't recognized is generated.

18. The device for processing data visualization information of claim 13, wherein the processor further implements the following steps:
when the input information is recognized incorrectly, third feedback information used for indicating that the input information is recognized incorrectly is generated.

19. The device for processing data visualization information of claim 15, wherein when implementing the step of determining a set of keywords based on the recognition result, the processor specifically implements the following steps:
recognizing the input information as a semantic text, and extracting the set of keywords from the semantic text, wherein the set of keywords comprises at least one field.

20. The device for processing data visualization information of claim 15, wherein when implementing the step of determining, based on the set of keywords, an interactive instruction corresponding to the recognition result, the processor specifically implements the following steps:
matching the set of keywords with data fields in the database; and when fields in the set of keywords match the data fields in the database, determining the interactive instruction based on a matching result.

21. The device for processing data visualization information of claim 20, wherein when implementing the step of determining, based on the set of keywords, an interactive instruction corresponding to the recognition result, the processor specifically implements the following steps:
generating fourth feedback information when fields in the set of keywords do not match the data fields in the database, wherein the fourth feedback information is used for indicating that fields in the set of keywords do not match the data fields in the database.

22. The device for processing data visualization information of claim 13, wherein the processor further implements the following steps:
when the input information is received, judging whether the input information is received successfully, wherein the input information comprises the voice; wherein the judging whether the input information is received successfully comprises: judging whether the voice is received successfully based on a first threshold.

23. A computer readable storage medium, storing computer readable program instructions, wherein when the computer readable program instructions are executed, the method for processing data visualization information according to claim 1 is executed.
